(19) United States
(12) Patent Application Publication
(10) Pub. No.: US 2002/0163858 A1
(43) Pub. Date: Nov. 7, 2002

(54) Seven-day clock

(76) Inventor: Eric Greenwood, Armstrong (CA)

Correspondence Address: ANTONY C. EDWARDS, SUITE 800, 1708 DOLPHIN AVENUE, KELOWNA, BC, V1Y 9S4, CA

(21) Appl. No.: 10/134,543

(22) Filed: Apr. 30, 2002

Related U.S. Application Data
(60) Provisional application No. 60/288,071, filed on May 3, 2001.

(51) Int. Cl. G04B 19/24

(52) U.S. Cl. 368/28

(57) ABSTRACT

A seven day clock includes an open-face and a single hand rotatably mounted to, and generally centrally disposed on, the face. A motor driver rotates the hand at a uniform rate of rotation, about an axis of rotation, in a plane parallel to the face. The hand rotates in complete 360 degree revolutions about the face once every seven complete days. The face is demarked into seven contiguous equal sectors each bounded by two radii extending radially outwardly from the axis of rotation and labelled consecutively with the consecutive days of a week. The clock is adapted for a user to apply removable writing so that the writing overlays the face, and so that the removable writing is within the sectors.

### CROSS REFERENCE TO RELATED APPLICATION

This application claims priority from U.S. Provisional Patent Application No. 60/288,071 filed May 3, 2001 entitled Seven-Day Clock.

### FIELD OF THE INVENTION

This invention relates to the field of clocks, and in particular to a clock wherein a single hand sweeps around a clock face once every seven days.

### BACKGROUND OF THE INVENTION

Generally speaking, in the prior art clocks are known for marking the passage of minutes and hours, and in many cases also seconds, during a single twenty-four hour period. The manner in which the elapse of time during the twenty-four hour period is indicated is the subject of innumerable designs and variations, and the prior art is replete of examples. Applicant is aware of examples of fanciful designs for example such as disclosed in U.S. Pat. No. D378,804 to Levine which discloses a timepiece having the hands shaped like golf clubs and wherein the numeral hours are replaced by golf hole flags.

Applicant is also aware of the Watch Face of U.S. Design Pat. No. D433,348, which appears to illustrate a week-at-a-glance wrist-watch face, and of U.S. Pat. No. D149,106 which issued to Berman for an Educational Appliance in which the face of a clock is divided into equally pie-shaped increments, each increment depicting various aspects of daily life which might be occurring at that particular time of the day. Similar themes are found in U.S. Design Pat. No. D146,757 which issued to Webb, U.S. Design Pat. No. D122,266 which issued to Hannan, and U.S. Design Pat. No. D 111,296 which issued to Barge.

Applicant is also aware of various scheduling devices which display combinations of clocks and calendars such as found in U.S. Pat. No. 3,964,196, and U.S. Pat. No. 5,271,172, both to Ureta, U.S. Pat. No. 4,709,493 to Sapp, U.S. Pat. No. 5,934,707 to Johnson, and Canadian Patent Application Number 2,095,239 filed by Svast.

Applicant is also aware of various other calendar clocks which have been proposed in the prior art. In particular, applicant is aware U.S. Pat. No. 50,430 which issued Oct. 10, 1865 to Gibson, U.S. Pat. No. 1,988,782 which issued to Canepa, U.S. Pat. No. 5, 654,940 which issued to Wei, U.S. Pat. No. 3,633,298 which issued to Grier, and U.S. Design Pat. No. D260,374 which issued to Umanoff.

Which is neither taught nor suggested, and which is one object of the present invention to provide, is a seven day clock wherein a user obtains at a single glance a view of the entire week, and in particular, a seven-day clock having a single hand which sweeps out 360° around the face of the clock which has been partitioned equally around the face of the clock into seven equal increments corresponding to the seven sequential days of the week, wherein the clock face is adapted for writing thereon by a user so that reminders or the like may be removably annotated onto the clock face.

### SUMMARY OF THE INVENTION

The seven day clock of the present invention includes an open-face and a single hand rotatably mounted to, and generally centrally disposed on, the face. A motor driver rotates the hand at a uniform rate of rotation, about an axis of rotation, in a plane parallel to the face. The hand rotates in complete 360 degree revolutions about the face once every seven complete days. The face is demarked into seven contiguous equal sectors each bounded by two radii extending radially outwardly from the axis of rotation and labelled consecutively with the consecutive days of a week.

The clock is adapted for a user to apply removable writing so that the writing overlays the face, and so that the removable writing is within the sectors. The sectors may be separated by contrasting lines along the radii.

In one embodiment the face is an open-faced planar writing medium, wherein open-faced includes having the face uncovered for access by a user to the face for writing thereon. In such an embodiment the face may be a white-board or a chalk-board.

### BRIEF DESCRIPTION OF THE DRAWINGS

FIG. 1 is, in front elevation view, the front of one embodiment of a clock according to the present invention.

FIG. 2 is, in front elevation view, a further embodiment of a clock according to the present invention.

FIG. 3 is, in front elevation view, a third embodiment of a clock according to the present invention.

FIG. 4 is, in plan view, the face of a clock according to a fourth embodiment of the present invention.

### DETAILED DESCRIPTION OF EMBODIMENTS OF THE INVENTION

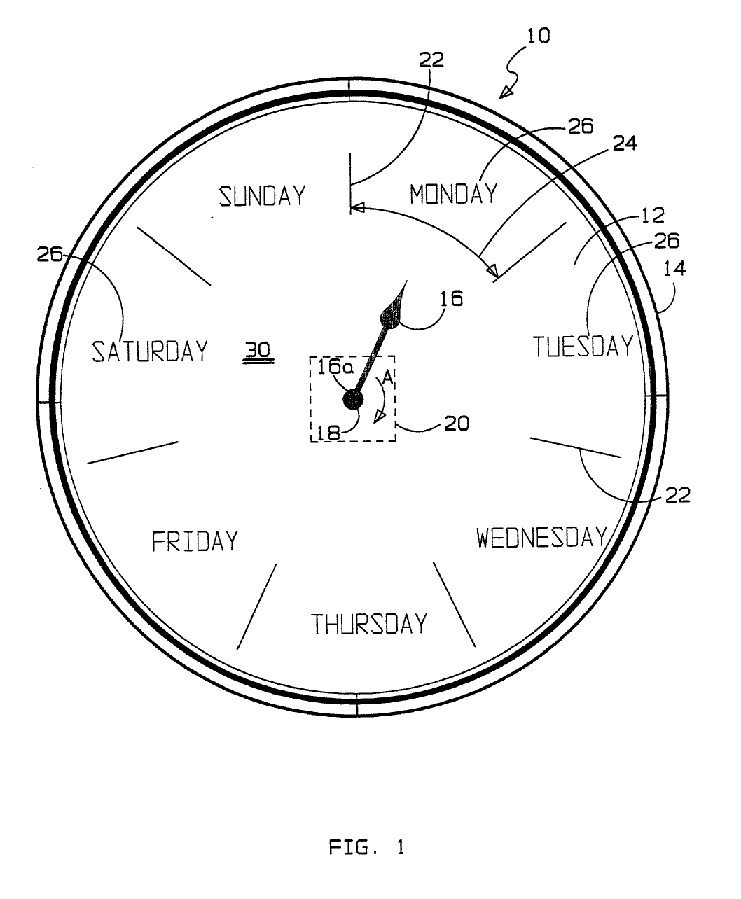

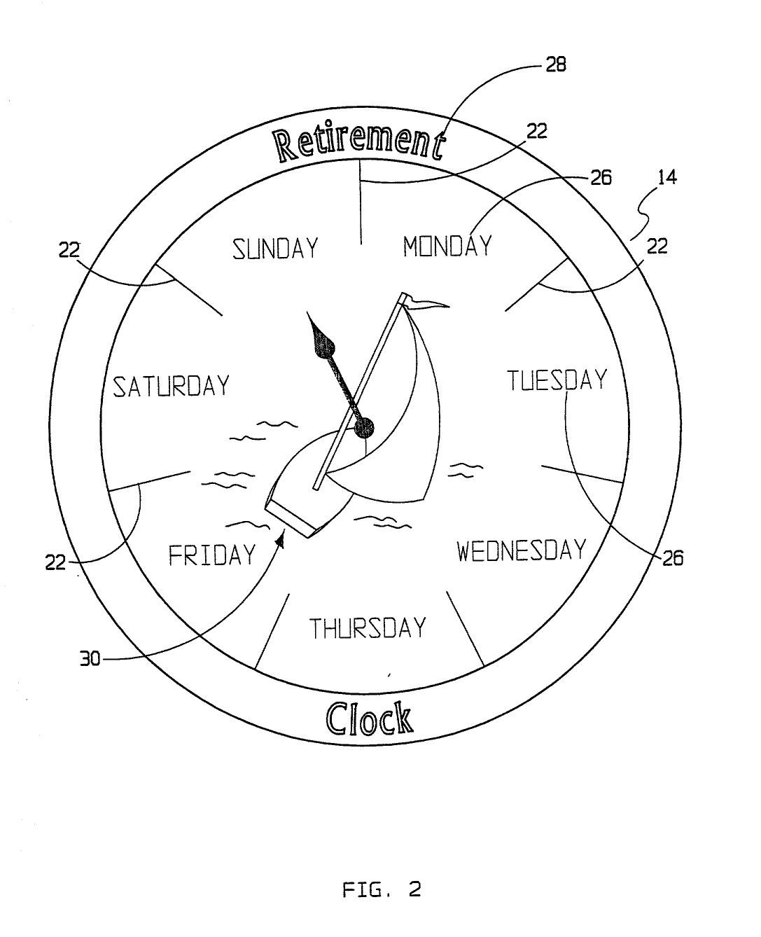

In embodiments of the present invention, such as illustrated in FIGS. 1-3, in which a clock 10 has a generally planar face 12 mounted within a frame 14, an indicating hand 16 is mounted for rotational movement relative to face 12 in direction A so as to sweep out a radial arc of 360 degrees every seven days. Face 12 may be open-faced or uncovered so as to permit writing thereon. Indicating hand 16 rotates about axis of rotation 18. Axis of rotation 18 extends orthogonally to the illustrations on face 12 and coincides with the axis of a drive shaft (not shown) extending between a motorized clock movement driver 20, illustrated by way of example in dotted outline, and the base end 16a of indicating hand 16. Motorized clock driver 20 may be a battery operated watch or clock mechanism geared to rotate the drive shaft and indicating hand 16 360 degrees about axis of rotation 18 every seven complete days, that is, once a week. By way of example, the clock driver may be a quartz movement such as manufactured by Quartex Company of Lake Geneva, Wis.

Axis of rotation 18 is generally centrally disposed relative to an equally radially spaced apart array of twenty four hour or single day division indicators such as radial lines 22. Radial lines 22 divide face 12 about axis 18 into seven equal radial arcs 24. Thus, assuming that direction A corresponds to a so-called clockwise movement of indicating hand 16, the radially adjacent array of seven radial arcs or sectors 24 on face 12 may be labelled by text or otherwise marked with an indicating symbol, icon or graphical day-of-the-week indicator 26 so that a user may at a glance know the present day of the week depending on the orientation of indicating hand 16. This is useful for users who, for example, have retired from the work force or others who enjoy a more leisurely paced life style, or may provide for someone who is retiring or otherwise assuming such a life style or as an educational device for a child. Indeed, a title block 28 may be employed on either frame 14 or face 12 to indicate, for example, that clock 10 is a “Retirement Clock”. Further, illustrations or photographical or other graphic material may be added in the center space 30 to provide a decorative or informative function.

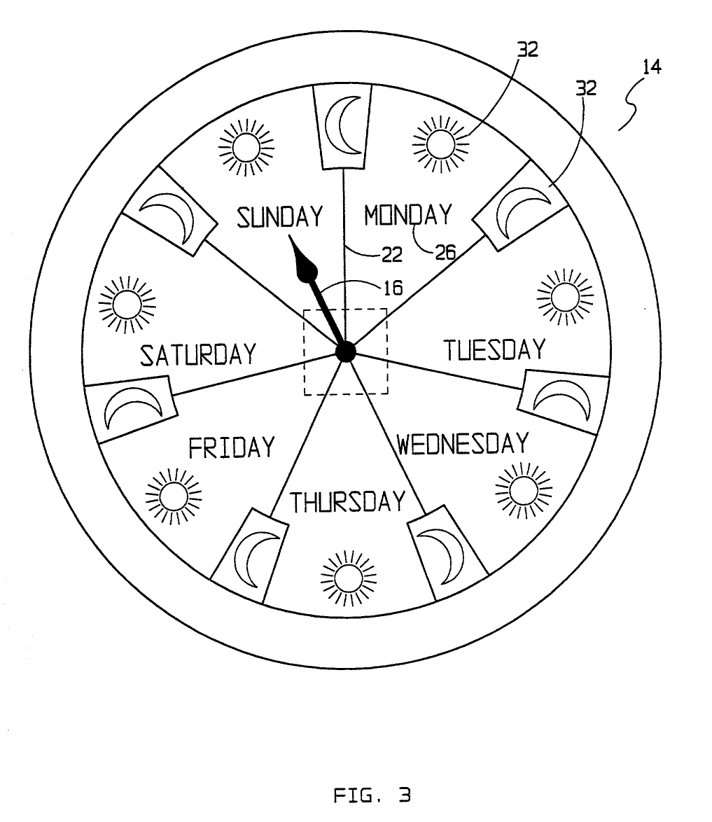

As better seen in FIG. 3, in addition to day indicators 26, for example for use where indicating hand 16 progresses in direction A at a constant speed of rotation about axis 18 (as opposed to a clock movement which moves indicating hand 16 in a series of abrupt stepped movements once each day, seven times a week), each radial arc 24 may have further indicators such as sun and moon indicators 32 to graphically illustrate the approximate time of day as indicating hand 16 sweeps across each radial arc 24.

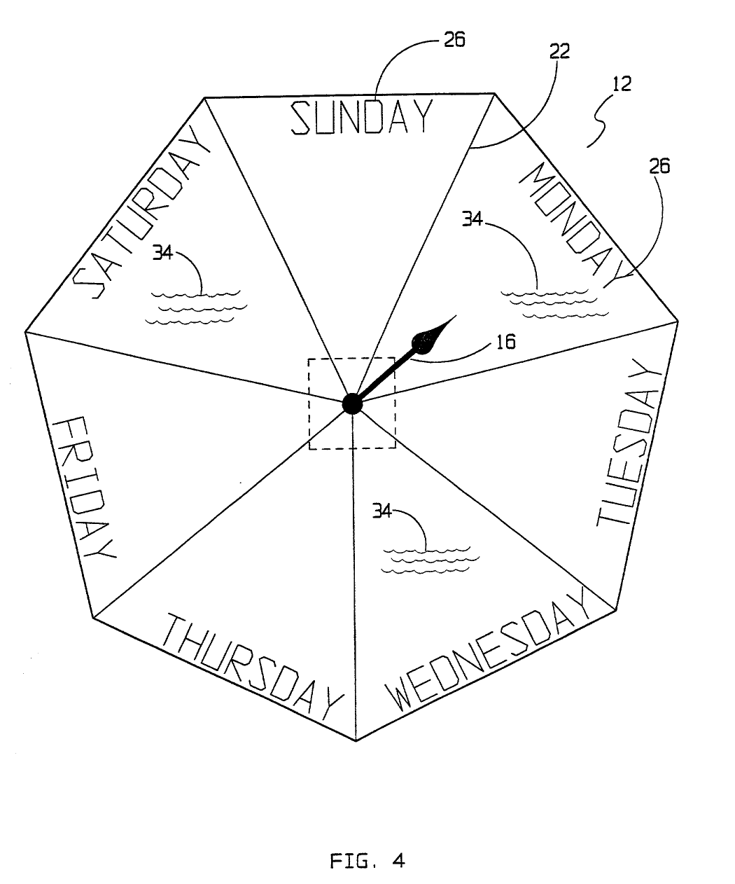

In the embodiment of FIG. 4, the clock is open-faced so that face 12 may be constructed by the use of a so-called white-board or chalk-board or other planar writing medium wherein a user may annotate daily events or appointments or the like in the spaces between radial lines 22 corresponding to the particular day of the week as indicated by day indicators 26. Such daily annotations 34, illustrated to be lines of horizontal handwriting, are understood to include hand text annotations of any size font or other removable or re-writable icons or reminders falling within radial arc 24 corresponding to a particular day of the week. In the white-board example such reminders are advantageously applied using a writing instrument which allows for removal of the annotations for example on a weekly basis. Thus where face 12 is a white board and so-called dry-ink markers are used to make annotations 34, a user may quickly change the recording of daily events and appointments from week to week and day to day. Alternatively, the clock may have a clear planar cover over face 12 for example a clear plastic or Lexan™ cover sandwiching hand 16 between the cover and face 12. In this embodiment the cover is adapted to be used as a message-board so that a user may annotate each day of the week with reminders which may be wiped off (for example using a grease pencil or other removable marker). In this embodiment the cover is closely adjacent face 12 to minimize parallax error between the messages and the intended sectors.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A seven day clock comprising:
a face, a single hand rotatably mounted to, and generally centrally disposed on said face for rotation of said hand at a uniform rate of rotation, about an axis of rotation, in a plane parallel to said face in complete 360 degree revolutions about said face once every seven complete days, wherein said face is demarked into seven contiguous equal sectors bounded by two radii extending radially outwardly from said axis of rotation,
wherein said clock is adapted for the application of removable writing so as to overlay said face with the removable writing within said sectors, and wherein said sectors are labelled consecutively with the consecutive days of a week.

2. The seven day clock of claim 1 wherein said face is an open-faced planar writing medium, open-faced so as to be uncovered for access by a user to the face for writing thereon.

3. The seven day clock of claim 2 wherein said face is a white-board.

4. The seven day clock of claim 2 wherein said face is a chalk-board.

5. The seven day clock of claim 1 wherein said face is labelled as a “retirement clock”.

6. The seven day clock of claim 1 wherein said sectors are separated by contrasting lines along said radii.

7. The seven day clock of claim 2 wherein said sectors are separated by contrasting lines along said radii.
